(19) United States
(12) Patent Application Publication
(10) Pub. No.: US 2023/0073722 A1
(43) Pub. Date: Mar. 9, 2023

(54) WIRELESS DEVICE, WIRELESS NETWORK SYSTEM, NON-TRANSITORY COMPUTER-READABLE STORAGE MEDIUM AND WIRELESS COMMUNICATION METHOD

(71) Applicant: KABUSHIKI KAISHA TOSHIBA, Tokyo (JP)

(72) Inventors: Miyuki OGURA, Tachikawa Tokyo (JP); Masahiro SEKIYA, Inagi Tokyo (JP); Takaomi MURAKAMI, Kamakura Kanagawa (JP); Toshihisa NABETANI, Kawasaki Kanagawa (JP); Tatsuma HIRANO, Kawasaki Kanagawa (JP)

(73) Assignee: KABUSHIKI KAISHA TOSHIBA, Tokyo (JP)

(21) Appl. No.: 17/682,310

(22) Filed: Feb. 28, 2022

(30) Foreign Application Priority Data
Sep. 3, 2021 (JP) 2021-143906

(51) Int. Cl. H04W 28/06; H04L 45/74; H04W 16/28

(52) U.S. Cl. CPC H04W 28/06; H04L 45/74; H04W 16/28

(57) ABSTRACT

According to one embodiment, a wireless device includes an identification information generation unit, a framing unit, and a transmission unit. The identification information generation unit generates identification information for identifying a packet among all other flooding packets to be relayed on the wireless network by arithmetic processing. The framing unit generates a wireless frame when a packet is transmitted to another wireless device as an origin node. The wireless frame includes the packet and the identification information generated by the identification information generation unit. The transmission unit transmits the wireless frame including the packet and the identification information generated by the identification information generation unit.

### CROSS-REFERENCE TO RELATED APPLICATIONS

This application is based upon and claims the benefit of priority from Japanese Patent Application No. 2021-143906, filed Sep. 3, 2021, the entire contents of which are incorporated herein by reference.

### FIELD

Embodiments described herein relate generally to a wireless device, a wireless network system, a non-transitory computer-readable storage medium and a wireless communication method.

### BACKGROUND

In a wireless mesh network, a path of packets such as IEEE 802.11s is constructed in advance. The constructed path is optimally maintained and controlled during operation according to variations in propagation environment and traffic. In this path-construction network, the relay quality of packets is greatly influenced by the selection of a path to which the packets are relayed.

In recent years, an application example in which autonomous mobile servicing robots (AMR) such as robots and drones are networked as Internet of Things (IoT) devices, has been studied. In this application example, a flooding wireless mesh network is attracting attention instead of a conventional path-construction wireless mesh network in order to obtain a stable propagation environment.

In the flooding wireless mesh network, a packet generated in the network may be received many times by the same relay station. Whenever the relay station receives the packet, it transmits the packet. The packet is thus reproduced a plurality of times and flooded in the network, which causes network congestion. It is therefore necessary to avoid network congestion caused by a plurality of same packets.

The wireless device that is in conformity with “Bluetooth SIG, Bluetooth Mesh Model Specification, Mesh Model” extracts a network PDU from a received wireless signal. When the extracted network PDU is the same as the one stored in the wireless device, the wireless device does not transmit a payload included in the network PDU. When the extracted network PDU is not stored in the wireless device, the wireless device stores the network PDU, generates a new network PDU including a payload included in the network PDU, and transmits a wireless signal with the new network PDU included therein.

That is, in order to determine whether or not to relay a received payload, the wireless device that is in conformity with “Bluetooth SIG, Bluetooth Mesh Model Specification, Mesh Model” needs a storage area for holding the network PDU received in the past, and the storage area is large because the field size of the network PDU is also large.

In addition, the wireless device that is in conformity with “Bluetooth SIG, Bluetooth Mesh Model Specification, Mesh Model” ensures the uniqueness of the payload in the network by address information and sequence numbers included in the Network PDU, and does not relay a redundant payload. In a wireless network that is not based on routing, however, the address information and sequence numbers are essentially relayed and need not be held in the wireless device, and causes a redundancy determination process to be complicated in the wireless device.

As described above, a wireless device that is in conformity with, for example, “Bluetooth SIG, Bluetooth Mesh Model Specification, Mesh Model” has problems that a storage area for storing a packet received in the past is large and a complicated process is required to determine whether or not a packet should be discarded using address information and sequence numbers which are essentially unnecessary.

### BRIEF DESCRIPTION OF THE DRAWINGS

FIG. 1 is a block diagram showing an example of a configuration of a wireless device of an embodiment.

FIG. 2 is a first diagram showing an example of data relaying in a wireless network configured by the wireless device of the embodiment.

FIG. 3 is a second diagram showing the example of data relaying in a wireless network configured by the wireless device of the embodiment.

FIG. 4 is a third diagram showing the example of data relaying in a wireless network configured by the wireless device of the embodiment.

FIG. 5 is a fourth diagram showing the example of data relaying in a wireless network configured by the wireless device of the embodiment.

FIG. 6 is a diagram showing an example of generating payload identification information in the wireless device of the embodiment.

FIG. 7 is a diagram showing an example of generating payload identification information by combining a hash function of generating a bit sequence based on a payload sequence and a RAND function of generating a bit sequence independently of the payload sequence in the wireless device of the embodiment.

FIG. 8 is a diagram illustrating a wireless process of the wireless device of the embodiment.

FIG. 9 is a block diagram showing an example of simultaneous transmission of the wireless device of the embodiment.

FIG. 10 is a flowchart showing a procedure for performing a frame transmission process of the wireless device of the embodiment.

FIG. 11 is a flowchart showing a procedure for performing a frame transmission process of the wireless device of the embodiment.

### DETAILED DESCRIPTION

Embodiments will be described hereinafter with reference to the accompanying drawings.

In general, according to one embodiment, a wireless device configures a wireless network together with other wireless devices. The wireless device includes an identification information generation unit, a framing unit, and a transmission unit. The identification information generation unit generates identification information for identifying a packet among all other flooding packets to be relayed on the wireless network by arithmetic processing. The framing unit generates a wireless frame when a packet is transmitted to another wireless device as an origin node. The wireless frame includes the packet and the identification information generated by the identification information generation unit. The transmission unit transmits the wireless frame including the packet and the identification information generated by the identification information generation unit.

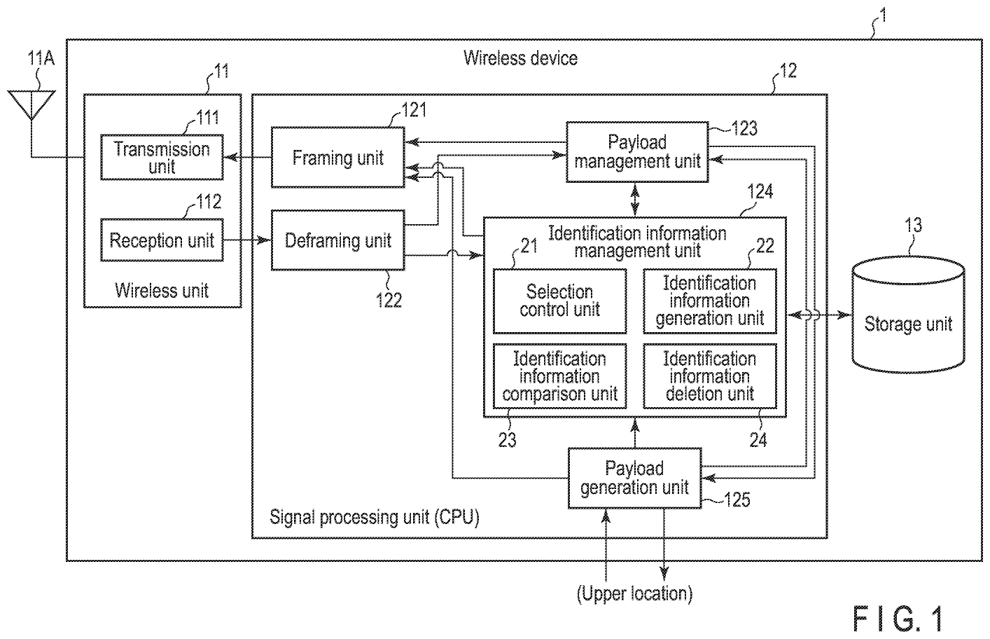

FIG. 1 is a block diagram showing an example of a configuration of a wireless device 1 of the embodiment.

The wireless device 1 configures a wireless network together with other wireless devices 1. The wireless device 1 can relay data included in a wireless frame by transmitting and receiving the wireless frame to and from the other wireless devices 1 by wireless transmission in a prescribed communication system.

As shown in FIG. 1, the wireless device 1 includes a wireless unit 11, a signal processing unit 12 and a storage unit 13.

The wireless unit 11 is a module that transmits and receives a wireless signal via, for example, an antenna 11A provided in the wireless device 1. The signal processing unit 12 is a module that performs various types of signal processing including signal processing necessary for data relaying. The storage unit 13 is a module (memory) that stores identification information to be described later, which is used to determine whether or not data should be relayed. The signal processing unit 12 may be a CPU that implements various functions by executing a program or may be an electric circuit configured to implement various functions. Assume here that the signal processing unit 12 is a CPU.

The wireless unit 11 includes a transmission unit 111 and a reception unit 112.

The transmission unit 111 receives wireless frames generated by the signal processing unit 12 and transmit them simultaneously via the antenna 11A by a prescribed wireless system. As a system for the simultaneous transmission, a multicast system, a broadcast system, a unicast system, with a plurality of wireless devices and the like can be considered.

The reception unit 112 extracts a wireless frame from the wireless signal received by the antenna 11A and transfers it to the signal processing unit 12.

The signal processing unit 12 includes a framing unit 121, a deframing unit 122, a payload management unit 123, an identification information management unit 124 and a payload generation unit 125. As described above, the signal processing unit 12 is assumed to be a CPU and thus each unit of the signal processing unit 12 is achieved by executing a program by the CPU. The respective units of the signal processing unit 12 are operated in cooperation with each other to allow the wireless device 1 to relay data included in the wireless frames as required.

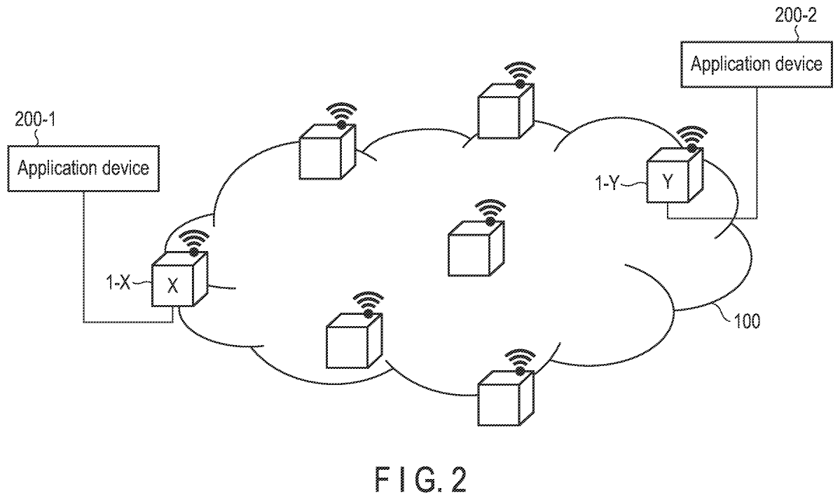

Referring now to FIGS. 2 through 5, a description will be given of how data is relayed within a wireless network 100 configured by the wireless devices 1.

The wireless network 100 is configured by a wireless device 1 having a common network identifier and an authentication key generated based on a predetermined authentication rule. If, for example, the wireless device 1 is inconformity with a wireless LAN, a common SSID is preset to the wireless device to output a beacon including a predetermined SSID when the device is started, select an optimum one of the peripheral wireless devices that output the same SSID and request it to be connection to the wireless device 1. At this time, a secure wireless connection can be provided in the wireless network 100 by exchanging the authentication key generated based on a predetermined authentication rule.

The wireless network 100 relays data from an application device 200 (200-1), which is connected to the wireless network 100 by wire or wireless, in multiple stages by the wireless devices 1 constituting the wireless network 100, and sends the data to another application device 200 (200-2) serving as a destination.

For example, when data is sent from the application device 200-1 to the application device 200-2, the wireless network 100 generally generates a header in which the host address of the application device 200-1 is used as a source address and the host address of the application device 200-2 is used as a destination address, and generates a packet in which the header is combined with the data to be sent. The packet is delivered to a wireless device 1 (1-X) in the wireless network 100 connected to the application device 200-1, relayed in the wireless network 100, sent to a wireless device 1 (1-Y) in the wireless network 100 connected to the application device 200-2, and delivered to the application device 200-2 in the same manner. If the application device 200 is an IoT device such as a sensor, it may be integrated with the wireless devices 1 constituting the wireless network 100. As a format of data relayed in the wireless network 100, an IP packet is effective when the application devices 200-1 and 200-2 belong to different wireless networks 100. When they belong to the same wireless network 100, the data format may be an ether frame constituting a header by the device address. Here, packets and ether frames are treated as payloads of wireless frames.

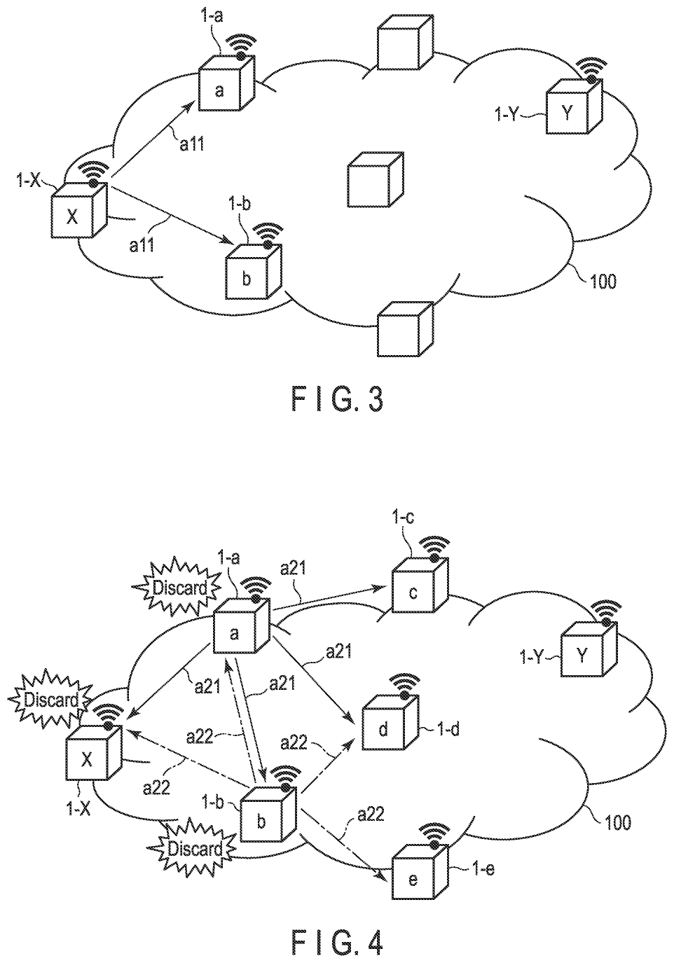

When the wireless device 1-X wirelessly relays and transmits a payload to the wireless device 1-Y in the wireless network 100, it generates wireless frames including the payload and simultaneously transmit the wireless frames as shown in FIG. 3 (a11). With this simultaneous transmission, the wireless frames are received by wireless devices 1-a and 1-b existing in the wireless area of the wireless device 1-X. The wireless devices 1-a and 1-b that have received the wireless frames determine whether or not the payload should be relayed. If they determine that the payload should be relayed, they generate new wireless frames including the received payload and simultaneously transmit the new wireless frames as shown in FIG. 4 (a21, a22).

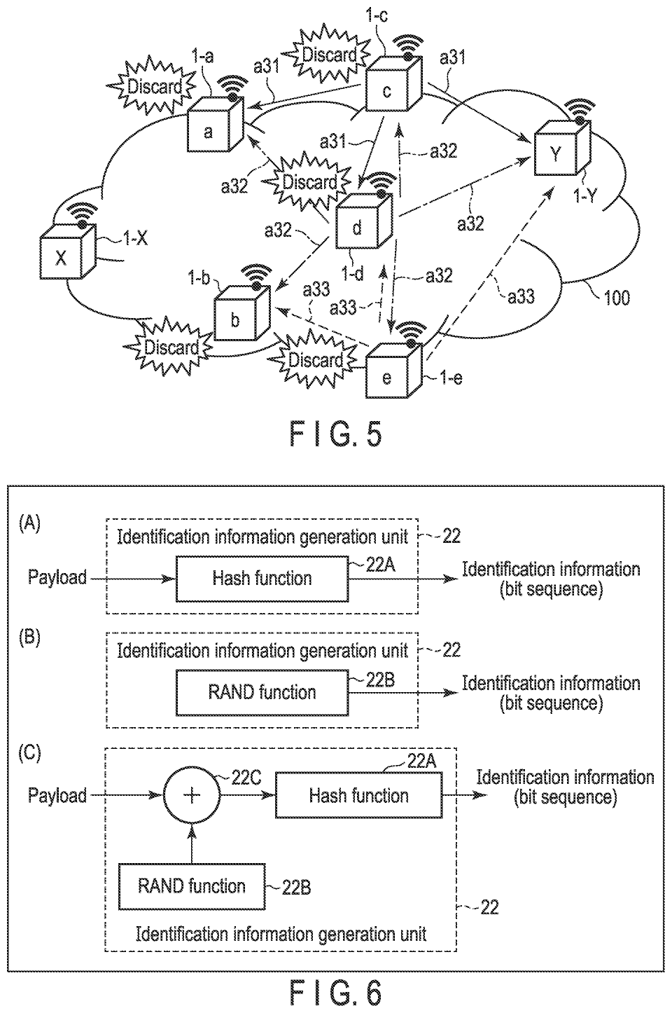

The wireless frames (a21) transmitted simultaneously from the wireless device 1-a are received by wireless devices 1-b, 1-c, 1-d and 1-X in the wireless area of the wireless device 1-a. The wireless devices 1-b, 1-c, 1-d and 1-X that has received the wireless frames determine whether or not the payload should be relayed. The wireless devices 1-c and 1-d determine that the payload should be relayed, generate new wireless frames including the received payload, and transmit the new wireless frames simultaneously as shown in FIG. 5 (a31, a32). On the other hand, the wireless devices 1-b and 1-X recognize that the payload in the received wireless frames has been relayed, determine that the wireless frames should not be relayed, and discard the received payload as shown in FIG. 4.

The wireless frames (a22) transmitted simultaneously from the wireless device 1-b are received by wireless devices 1-a, 1-d, 1-e and 1-X in the wireless area of the wireless device 1-b. The wireless devices 1-a, 1-d, 1-e and 1-X that has received the wireless frames determine whether or not the payload should be relayed. The wireless devices 1-d and 1-e determine that the payload should be relayed, generate new wireless frames including the received payload, and transmit the new wireless frames simultaneously as shown in FIG. 5 (a32, a33). On the other hand, the wireless devices 1-a and 1-X recognize that the payload in the received wireless frames has been relayed, determine that the wireless frames should not be relayed, and discard the received payload as shown in FIG. 4.

Since the wireless devices 1-c, 1-d and 1-e generate new wireless frames and transmit them simultaneously (a31, a32, a33), the wireless device 1-Y can receive the payload.

As described above, in the present embodiment, without presetting a relay route in the wireless network 100, the wireless device 1 simultaneously transmits wireless frames including a payload to relay data and determine whether or not the received payload has been relayed, thereby preventing the same payload from being retransmitted to reduce redundant traffic in the wireless network 100.

For example, the wireless device that is in conformity with “Bluetooth SIG, Bluetooth Mesh Model Specification, Mesh Model” holds a network PDU received in the past and determines whether or not the received payload should be relayed based upon the address information and sequence numbers included in the network PDU. Since the field size of the network PDU is large, a storage area for holding the network PDU becomes large. Furthermore, in the flooding wireless network, a complicated process is required to determine whether or not the payload should be relayed using the address information and sequence numbers which are essentially unnecessary to perform a relay operation.

The wireless device 1 of the present embodiment has a mechanism for easily performing a process for discarding a packet received in duplicate, which makes a small impact on a storage area. This mechanism will be described in detail below.

Referring back to FIG. 1, a description of the configuration of the wireless device 1 and, more specifically, a description of each unit in the signal processing unit 12 will be continued.

The framing unit 121 generates wireless frames including identification information generated by an identification information generation unit 22, which will be described later, in the identification information management unit 124, and a payload generated by the payload generation unit 125, and delivers them to the wireless unit 11. The generation of identification information by the identification information generation unit 22 will be described later.

The deframing unit 122 extracts a wireless frame from the signal received by the wireless unit 11, and extracts identification information and a payload from the wireless frame. The deframing unit 122 delivers the identification information to the identification information management unit 124 and delivers the payload to the payload management unit 123.

When the payload generation unit 125 generates a payload to be transmitted, the payload management unit 123 instructs the identification information generation unit 22 to generate identification information for identifying the payload generated by the payload generation unit 125 from other payloads in the wireless network 100, and temporarily holds the payload generated by the payload generation unit 125 in such a manner that the payload can correspond to identification information to be generated by the identification information generation unit 22. When the payload management unit 123 instructs the identification information generation unit 22 to generate identification information, it delivers all or part of the payloads to the identification information generation unit 22, or sends only a command for instructing the generation of identification information to the identification information generation unit 22, without delivering a payload thereto. Whether all or part of the payloads is delivered to the identification information generation unit 22 or only a command for instructing the generation of identification information is sent thereto without delivering a payload depends on a method of generating identification information by the identification information generation unit 22 to be described later. Upon receiving the completion of generation of identification information from the identification information generation unit 22, the payload management unit 123 delivers the held payload to the framing unit 121.

In addition, the payload management unit 123 receives the payload extracted by the deframing unit 122. Upon receipt of an instruction from the identification information management unit 124, the payload management unit 123 delivers the payload to the framing unit 121, deletes it or delivers it to the payload generation unit 125.

The identification information management unit 124 manages identification information for identifying a payload from other payloads in the wireless network 100, which is capable of determining, by a simple process, whether the payload held by the payload management unit 123 should be delivered to the framing unit 121, deleted or delivered to the payload generation unit 125. The identification information management unit 124 includes a selection control unit 21, an identification information generation unit 22, an identification information comparison unit 23 and an identification information deletion unit 24.

The selection control unit 21, in cooperation with the payload management unit 123, maintains a relationship in correspondence between identification information transferred between the framing unit 121 or the deframing unit 122 and the identification information management unit 124 and a payload temporarily held by the payload management unit 123, and appropriately selects a module to be operated among the identification information generation unit 22, identification information comparison unit 23 and identification information deletion unit 24 such that the payloads are transmitted and received in order.

Upon receipt of an instruction from the payload management unit 123, the identification information generation unit 22 generates identification information by a predetermined algorithm. More specifically, the identification information generation unit 22 generates identification information that do not easily have the same value even if the wireless devices 1 in the wireless network 100 independently generate identification information by the predetermined algorithm. The identification information generation unit 22 delivers the generated identification information to the framing unit 121. The identification information generated by the identification information generation unit 22 is, for example, a bit sequence. Several examples of generating identification information by the identification information generation unit 22 will be described with reference to FIG. 6.

FIG. 6(A) shows an example of generating a bit sequence having a predetermined length using a hash function 22A with a payload to be transmitted as an input. FIG. 6(B) shows an example of generating a bit sequence independently of a payload sequence. In this case, the identification information generation unit 22 can use, for example, a RAND function 22B for generating a random number.

FIG. 6(C) shows an example in which a bit sequence generation method of FIG. 6(A) and a bit sequence generation method of FIG. 6(B) are combined. For example, an arithmetic circuit 22C for obtaining exclusive OR may be used to embed a bit string (for example, 0x00 to 0xFF) randomly generated by, for example, the RAND function 22B into a payload to be transmitted and thus generate a bit sequence with the result as an input of the hash function 22A. This is effective in preventing the same bit sequence from being generated when payloads of the same pattern appear at a high frequency (three payloads in this case) such as raising an arm by 10 degrees to raise the arm by 30 degrees, for example, under robot control. Assuming that the same bit sequence is generated, the second and subsequent payloads are likely to be discarded without being relayed, with the result that the arm is raised only by 10 degrees.

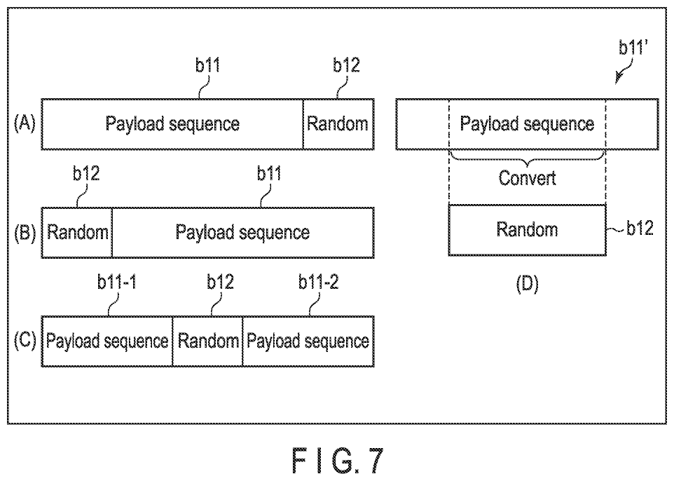

Next, several examples of bit sequence generation in the case of FIG. 6(C) are shown in FIG. 7.

FIG. 7(A) shows an example in which a generated random sequence b12 is added after a payload sequence b11. FIG. 7(B) shows an example in which the generated random sequence b12 is added to the beginning of the payload sequence b11. FIG. 7(C) shows an example in which the payload sequence b11 is divided into two (b11-1, b11-2) and a generated random sequence is added to the middle of the payload sequence b11.

FIG. 7(D) shows an example in which part of the payload sequence b11 is subjected to arithmetic processing by the generated random sequence b12 to convert the payload sequence b11 (payload sequence b11′). The object of the arithmetic processing can sufficiently be attained by a simple process including bit operations of AND and EXOR, addition and subtraction.

Thus, the bit sequence generation processing by the identification information generation unit 22 can easily be achieved by the software of the CPU incorporated in the wireless device 1. In addition, regardless of the values of an MAC address and an IP address which are assigned to the wireless device 1 and the communication path information of a network such as a transmission source address and a transmission destination address, the wireless device 1 can generate the same bit sequence independently. Even though a plurality of wireless devices 1 generate the bit sequences simultaneously, the generated bit sequences may not have the same value with a high probability. This is effective in more efficiently reducing redundant traffic in the wireless network 100 in which one payload is transmitted to a plurality of wireless devices 1 existing in a communication area.

When the identification information generation unit 22 generates identification information, it may instruct the identification information comparison unit 23 to check whether or not the generated identification information is stored in the storage unit 13. If the reply from the identification information comparison unit 23 is “the same identification information is not stored in the storage unit 13”, the identification information generation unit 22 delivers the generated identification information to the framing unit 121 and replies to the payload management unit 123 about the completion of generation of the identification information. On the other hand, if the reply is “the same identification information is stored in the storage unit 13”, the identification information generating unit 22 generates identification information again. The identification information generation unit 22 repeats generating identification information until the reply that “the same identification information is not stored in the storage unit 13” is obtained from the identification information comparison unit 23. Thus, even though the same identification information as that of another payload propagating on the wireless network 100 is accidentally generated, other identification information is generated again.

Referring back to FIG. 1, a description of the configuration of the wireless device 1 and, more specifically, a description of each unit in the signal processing unit 12 will be continued.

The identification information comparison unit 23 compares and collates the identification information extracted from the wireless frame by the deframing unit 122 with the identification information stored in the storage unit 13. If the identification information extracted from the wireless frame is not stored in the storage unit 13, the identification information comparison unit 23 stores the identification information extracted from the wireless frame in the storage unit 13 and instructs the payload management unit 123 to frame its corresponding payload to relay it to the next wireless device 1. If the identification information extracted from the wireless frame has already been stored in the storage unit 13, the identification information comparison unit 23 instructs the payload management unit 123 to delete its corresponding payload.

Note that the wireless device 1 can determine whether or not the payload held in the payload management unit 123 sets the wireless device 1 as a terminal node on the wireless network 100. When the wireless device 1 is not a terminal node on the wireless network 100, the payload held in the payload management unit 123 is relayed to another wireless device 1 or discarded based on the comparison result of the identification information comparison unit 23 as described above. On the other hand, when the wireless device 1 is a terminal node on the wireless network 100, the payload held in the payload management unit 123 is not relayed to another wireless device 1 but is delivered to the high-order layer. That is, based on the comparison result of the identification information comparison unit 23, the wireless device 1 determines whether or not the payload is delivered to the high-order layer or discarded. In this case, the identification information comparison unit 23 instructs the payload management unit 123 to deliver the corresponding payload to the payload generation unit 125 instead of instructing the payload management unit 123 to frame the corresponding payload in order to relay the payload to the next wireless device 1.

Whether or not the payload held in the payload management unit 123 sets the wireless device 1 as a terminal node on the wireless network 100 can be achieved by confirming the destination address of an IP header if the configuration of the payload is an IP packet. When the wireless device 1 is not provided with an IP address, the number of relays from the origin node to the terminal node may be set as TTL and decremented each time the payload is relayed by the wireless device 1 in the wireless network 100 to determine that the wireless device 1 whose TTL is 0 as a terminal node. In addition, a wireless device 1 that communicates with an external network may be determined in advance, and the wireless device 1 may always function as a gateway (GW).

Furthermore, when the identification information comparison unit 23 compares and collates the identification information generated by the identification information generation unit 22 with the identification information stored in the storage unit 13 in response to an instruction from the identification information generation unit 22, if the identification information generated by the identification information generation unit 22 is not stored in the storage unit 13, the identification information comparison unit 23 replies to the identification information generation unit 22 about only the comparison result, without storing the identification information in the storage unit 13.

The identification information deletion unit 24 determines that the possibility that a payload corresponding to the identification information is transmitted from another wireless device 1 has become sufficiently low to delete the identification information whose management becomes unnecessary from the storage unit 13. This can easily be achieved by assigning a timer to each identification information string. Assume, for example, as shown in FIG. 3 that the wireless device 1-a receives a new payload from the wireless device 1-X at time t (a11). The wireless device 1-a extracts identification information from the wireless frame and stores it in the storage unit 13 to start a timer (T). As shown in FIG. 4, for example, the wireless device 1-a simultaneously transmits the payloads to the surrounding wireless devices at time t+h (a21), the wireless devices 1-c and 1-d newly receive the payload, and the wireless devices 1-b and 1-X receive the payload in duplicate. The received payloads are discarded in the wireless devices 1-b and 1-X based on the collation between the corresponding identification information and that in the storage unit 13, and are simultaneously transmitted at time t+2h in the wireless devices 1-c and 1-d as shown in FIG. 5, for example, (a31, a32).

On the other hand, the wireless device 1-a receives the payload from the wireless device 1-b at time t+h, as shown in FIG. 4, for example (a22), and discards the payload based on the collation between the corresponding identification information and that in the storage unit 13. Furthermore, as shown in FIG. 5, for example, the wireless device 1-a receives the payload from the wireless devices 1-c and 1-d at time t+2h (a31, a32) and discards the payload based on the collation between the corresponding identification information and that in the storage unit 13.

At time t+2h, for example, as shown in FIG. 5, the payload from the wireless device 1-X is received by the wireless device 1-Y that is a terminal node. Thus, the payload need not reside in the network any longer.

It is thus possible to avoid retransmitting a duplicate payload to be received before the payload reaches the terminal node by setting the timer T of identification information corresponding to the payload to t+2h or more as a threshold. The timer T can be determined with reference to the number of wireless devices constituting the wireless network 100, the number of relays to the terminal node, and the network topology.

The buffer of the storage unit 13 needs to have a sufficient depth depending on the frequency of payload transmission of the wireless device 1 and the number of relays to the target terminal node. For example, even though the number of relays is the same, the generation of 100 payloads per second requires a deeper buffer than that of 10 payloads per second.

The payload generation unit 125 is a function required when the wireless device 1 corresponds to the origin or termination of a payload propagating on the wireless network 100. For example, as shown in FIG. 3, in the wireless device 1-X serving as an origin node, the payload generation unit 125 receives data, which is generated in a predetermined format, from the application device 200-1 or data from an application incorporated into the wireless device 1, that is, receives data from the high-order layer to generate a payload of the wireless frame. In the wireless device 1-Y serving as a terminal node, the payload generation unit 125 converts the payload received from the payload management unit 123 into a high-order frame of a predetermined format and delivers the high-order frame to the high-order layer.

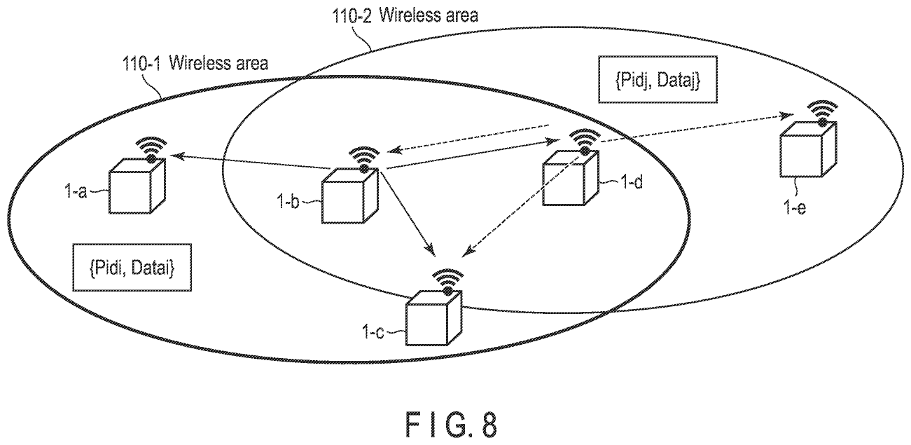

The wireless process of the wireless device 1 will be described below with reference to FIG. 8.

For example, the wireless device 1-b transmits wireless frames simultaneously, and other wireless devices 1-a, 1-c and 1-d existing in the wireless area 110-1 of the wireless device 1-b receive the frames.

The wireless device 1-d transmits wireless frames simultaneously, and other wireless devices 1-b, 1-c and 1-e existing in the wireless area 110-2 of the wireless device 1-d receives the frames.

In the present embodiment, the wireless devices 1 constituting the wireless network 100 repeat transmitting the wireless frames simultaneously to make it possible to relay a payload and deliver it to a target wireless device 1.

Assume that for example, the wireless device 1-b simultaneously transmits wireless frames including identification information (Pidᵢ) and a payload (Dataᵢ). If the payload (Dataᵢ) is received from the wireless device 1-a, the wireless device 1-a transmits (relays) no payload to avoid duplicate transmission. Then, assume that the wireless device 1-d simultaneously transmits wireless frames including identification information (Pidᵢ) and a payload (Dataᵢ) and the wireless devices 1-b, 1-c and 1-e receives the frames. Since this payload (Dataᵢ) is duplicated in the wireless devices 1-b and 1-c in the wireless area 110-1, the wireless device 1-d transmits no payload.

As described above, the wireless frames including the payload (Dataᵢ) are repeatedly and simultaneously transmitted by the wireless device 1 in the wireless network 100 to make it possible to automatically select a communicable path such as the wireless devices 1-a→1-b→1-d→1-e and deliver it to a target wireless device 1.

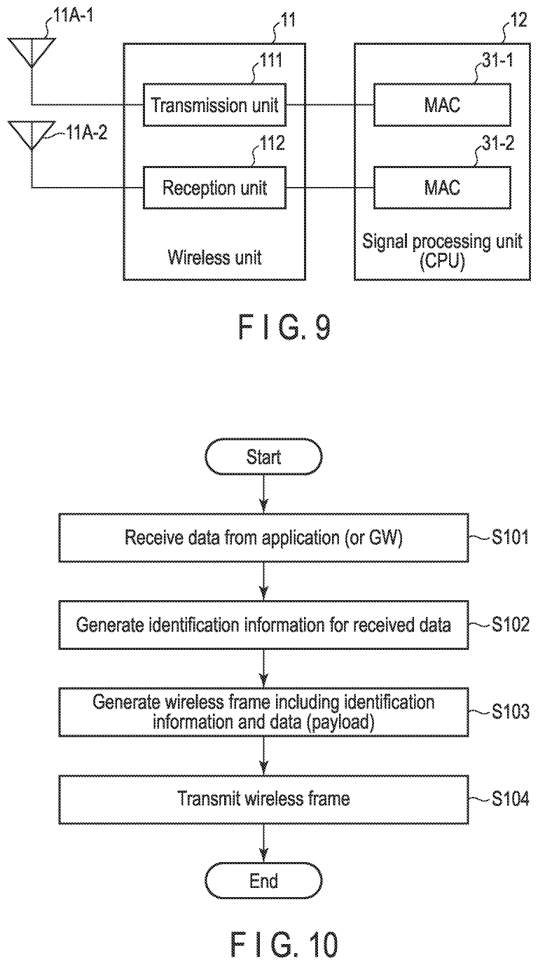

Simultaneous transmission can easily be achieved by, for example, a multicast system of IEEE 802.11. In another configuration, an MAC address for reception can be set to the same value by all wireless devices in the network. For example, as shown in FIG. 9, the physical address of an MAC 31-1 for performing framing is set to a value unique to each wireless device 1 in the wireless network 100, and the physical address of an MAC 31-2 for performing deframing is set to a value common to the wireless devices in the wireless network 100. The MAC 31-1 is configured as an STA interface and the MAC 31-2 is configured as an AP interface to transmit a wireless frame to the AP with which the STA is associated, with the result that the peripheral AP of the same address can receive the frame. When a wireless multi-hop network is configured using the wireless device 1 of the present embodiment, it is unnecessary to construct a communication path for payloads by the MAC address.

As described above, in the present embodiment, it is not necessary to construct, manage or control a packet relay path in the network using an MAC address and thus it is possible to achieve a wireless mesh network and a wireless relay station which can automatically relay a packet with highly reliability.

FIG. 10 is a flowchart showing a procedure for performing a frame transmission process of the wireless device 1 of the present embodiment.

Upon receiving data from an application or a GW (S101), the wireless device 1 generates identification information for recognizing the data to be distinguishable from other data on the wireless network 100 (S102). The wireless device 1 generates a wireless frame including the generated identification information and data (payload) (S103), and transmits the generated wireless frame (S104).

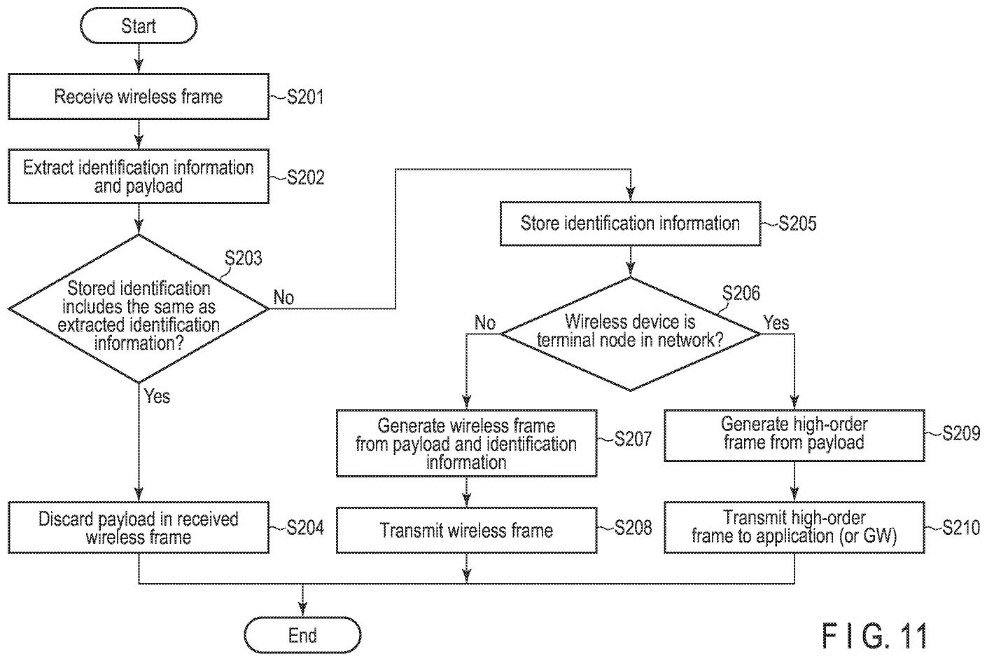

FIG. 11 is a flowchart showing a procedure for performing a frame reception process of the wireless device 1 of the present embodiment.

Upon receiving a wireless frame (S201), the wireless device 1 extracts identification information and a payload from the wireless frame (S202). The wireless device 1 determines whether or not the stored identification information includes the same as the identification information extracted from the wireless frame (S203). When the stored identification information includes the same (Yes in S203), the wireless device 1 discards the payload in the received wireless frame (S204).

When the stored identification information does not include the same (No in S203), the wireless device 1 first stores the identification information (S205). Then, the wireless device 1 determines whether or not the wireless device is a terminal node in the wireless network 100 regarding the wireless frame (S206).

When the wireless device 1 is not a terminal node (No in S206), it generates a wireless frame from the payload extracted from the received wireless frame and the identification information in order to relay the payload to another wireless device 1 (S207), and transmits the generated wireless frame (S208).

When the wireless device 1 is a terminal node (Yes in S206), it generates a high-order frame from the payload extracted from the wireless frame in order to deliver the payload to a high-order layer from the received wireless frame (S209), and transmits the generated high-order frame to an application or a GW (S210).

In accordance with the comparison of items of identification information in step S203, a payload received in duplicate is discarded in step S204. Thus, no payload is relayed in duplicate to another wireless device 1 in step S208 or no payload is delivered in duplicate to the high-order layer in step S210.

As described above, in the wireless device 1 of the present embodiment, the identification information management unit 124 cooperates with the payload management unit 123 to generate identification information, hold the received identification information, and use the held identification information to delete the payload received in duplicate and delete old identification information from the held identification information. Therefore, large-sized data such as a network PDU need not be held and information unique to the wireless device 1 such as an address need not be used, with the result that redundant traffic can be reduced from the wireless network 100. Since, furthermore, these are easily achieved by software to be executed by the CPU, an efficient relay operation can be performed without increasing in costs.

The wireless device 1 of the present embodiment can easily perform a process for discarding a packet received in duplicate, which makes a small impact on the storage area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless device which configures a wireless network together with other wireless devices, comprising:
an identification information generation unit configured to generate identification information for identifying a packet among all other flooding packets to be relayed on the wireless network by arithmetic processing;
a framing unit configured to generate a wireless frame when a packet is transmitted to another wireless device as an origin node, the wireless frame including the packet and the identification information generated by the identification information generation unit; and
a transmission unit configured to transmit the wireless frame including the packet and the identification information generated by the identification information generation unit.

2. The wireless device of claim 1, further comprising:
a deframing unit configured to extract identification information from a wireless frame received from another wireless device;
a storage unit configured to store the identification information extracted by the deframing unit; and
an identification information comparison unit configured to, when the wireless frame is received from said another wireless device, compare the identification information extracted by the deframing unit from the received wireless frame with the identification information stored in the storage unit to determine whether or not to relay a packet included in the received wireless frame.

3. The wireless device of claim 2, wherein:
the identification information comparison unit is configured to determine that the packet included in the received wireless frame is relayed when the storage unit stores no identification information that coincides with the identification information extracted by the deframing unit; and
the framing unit is configured to generate a wireless frame including the packet included in the received wireless frame and the identification information extracted by the deframing unit to relay the packet.

4. The wireless device of claim 2, wherein the identification information generation unit is configured to, when the storage unit stores identification information that coincides with the generated identification information, discard the generated identification information and generates identification information again.

5. The wireless device of claim 2, wherein the identification information comparison unit is configured to, when the packet included in the received wireless frame is a packet with the wireless device as a terminal node, compare the identification information extracted by the deframing unit from the received wireless frame with the identification information stored in the storage unit to determine whether or not to transfer the packet included in the received wireless frame to a high-order layer.

6. The wireless device of claim 2, further comprising an identification information deletion unit configured to delete from the storage unit identification information which has been stored in the storage unit for a longer period of time than a threshold value.

7. The wireless device of claim 1, wherein the identification information generation unit is configured to receive data to be stored in the packet to generate a bit sequence having a first bit length using a hash function.

8. The wireless device of claim 1, wherein the identification information generation unit is configured to generate a bit sequence having a first bit length using a function that generates a random number.

9. The wireless device of claim 1, wherein the identification information generation unit is configured to generate a random number sequence using a function that generates a random number, embed the generated random number sequence into data to be stored in the packet, and generate a bit sequence having a first bit length using a hash function by applying the data into which the random number sequence is embedded.

10. A wireless network system in which a wireless network is configured by a plurality of wireless devices, comprising:
a first wireless device configured to transmit a packet to another wireless device as an origin node; and
a second wireless device configured to relay the packet;
a third wireless device configured to receive the packet as a terminal node,
wherein:
the first wireless device is configured to generate identification information for identifying the packet on the wireless network and generates a wireless frame including the packet and the generated identification information;
the second wireless device is configured to
extract identification information from a wireless frame received from another wireless device,
store the extracted identification information, and
compare, when the wireless frame is received from said another wireless device, the identification information extracted from the received wireless frame with the stored identification information to determine whether or not to relay a packet included in the received wireless frame; and
the third wireless device is configured to
extract identification information from a wireless frame received from another wireless device,
store the extracted identification information, and
compare, when the wireless frame is received from said another wireless device, the identification information extracted from with the stored identification information to determine whether or not to transfer a packet included in the received wireless frame to a high-order layer.

11. A non-transitory computer-readable storage medium having stored thereon a computer program which is executable by a computer which controls an operation of a wireless device that configures a wireless network together with other wireless devices, the computer program controlling the computer to execute functions of:
generating identification information for identifying a packet among all other flooding packets to be relayed on the wireless network;
generating a wireless frame when the packet is transmitted to another wireless device as an origin node, the wireless frame including a packet and the generated identification information;
extracting identification information from a wireless frame received from another wireless device;
storing the extracted identification information;
when a packet included in a wireless frame received from another wireless device is not a packet with the wireless device as a terminal node, comparing the identification information extracted from the received wireless frame with the stored identification information to determine whether or not to relay the packet included in the received wireless frame; and
when a packet included in a wireless frame received from another wireless device is a packet with the wireless device as a terminal node, comparing the identification information extracted from the received wireless frame with the stored identification information to determine whether or not to transfer the packet included in the received wireless frame to a high-order layer.

12. A wireless communication method executed by a wireless device which configures a wireless network together with other wireless devices, the method comprising:
generating identification information for identifying a packet among all other flooding packets to be relayed on the wireless network;
generating a wireless frame when the packet is transmitted to another wireless device as an origin node, the wireless frame including a packet and the generated identification information;
extracting identification information from a wireless frame received from another wireless device;
storing the extracted identification information;
when a packet included in a wireless frame received from another wireless device is not a packet with the wireless device as a terminal node, comparing the identification information extracted from the received wireless frame with the stored identification information to determine whether or not to relay the packet included in the received wireless frame; and
when a packet included in a wireless frame received from another wireless device is a packet with the wireless device as a terminal node, comparing the identification information extracted from the received wireless frame with the stored identification information to determine whether or not to transfer the packet included in the received wireless frame to a high-order layer.
